(19) United States
(12) Patent Application Publication
(10) Pub. No.: US 2005/0042488 A1
(43) Pub. Date: Feb. 24, 2005

(54) Transportable solid oxide fuel cell generator

(75) Inventors: Alan Niedzwiecki, Laguna Beach, CA (US); Andris Abele, San Clemente, CA (US); Neel Sirosh, Irvine, CA (US)

Correspondence Address: GREENBERG TRAURIG LLP, Suite 400E, 2450 Colorado Avenue, Santa Monica, CA, 90404, US

(73) Assignee: Quantum Technologies

(21) Appl. No.: 10/644,614

(22) Filed: Aug. 19, 2003

(51) Int. Cl. H01M 8/12; H01M 8/06

(52) U.S. Cl. 429/30; 429/34; 429/19

(57) ABSTRACT

A transportable solid oxide fuel cell and balance of plant in a portable enclosure. A fuel supply is provided in the enclosure. The fuel supply is refillable. Power conditioning of the electricity provided is also provided as part of the enclosure.

### BACKGROUND OF THE INVENTION

1. Field of the Invention

This invention relates to a solid oxide fuel cell device to provide portable electrical power. Among other applications, the device can be used for energy generation and distribution industries.

2. Description of the Related Art

Fuel cells generate electricity, quietly and cleanly. The Solid Oxide Fuel Cell (SOFC) is one of the most mature fuel cell technologies. It operates temperatures normally exceeding 650 C. The SOFC generates electricity by stripping electrons off oxygen. Oxygen from the air flows through the cathode. Negatively charged oxygen ions (Equation 1) migrate through the electrolyte membrane and react with hydrogen at the anode to form water. When hydrogen is used as a fuel Equation 2 exemplifies the anode reaction. Equation 3 shows the overall reaction. Carbon Monoxide may be used as a fuel the anode reaction is shown in Equation 4. Methane may also be used as a fuel, as shown in equation 5. A blend of the aforementioned fuels may also be used. Depending on the fuel water, carbon dioxide or both are the by-product of the generation of electricity.
1/2 O₂+2e⁻→O²⁻ (cathode). Equation 1
H₂+O²⁻→H₂O+2e⁻ Equation 2
H₂₊1/2 O₂→H₂O (anode). Equation 3
CO+O²⁻→CO₂+2e⁻ Equation 4
CH₄+4O²⁻→2H₂O+CO₂+8e^{- (anode).} Equation 5

SOFC's are known in the arts primarily for stationary use for use with very small portable electronic devices with small power needs.

Disruptions in the electrical power grid or supply interfere with the safety and order of society. To minimize electrical disruptions portable combustion back-up power generators are available. Combustion-type power generators in the over 50 KW range using gasoline or diesel fuel are noisy operating 60 to 100 decibels and the exhaust emitted posses serious health risks. Since 1990, diesel exhaust has been listed as a known carcinogen under California's Proposition 65. In 1998, the California Air Resources Board (CARB) listed diesel particulate as a toxic air contaminant. Also, see Findings of the Scientific Review Panel (SRP): “The Report on Diesel Exhaust as adopted at the Panel's Apr. 22, 1998”. It would be desirable to have a portable power supply which could provide at lest 50 KW of electrical power with reduce noise and pollution.

### SUMMARY OF THE INVENTION

The transportable SOFC electrical power generator carries its own fuel supply.

In one embodiment about 35 KG of hydrogen, which provides for extended operation. The hydrogen can be carried as a compressed gas stored in tanks at high pressure.

The power SOFC generator can be placed in a transportable trailer or in a transportable enclosure.

In another embodiment the transportable SOFC electrical power generator contains a hydrogen producing system, such as a reformer using hydrogen rich fuels, an electrolyzer, and/or electrolytic cell. The hydrogen producing system can be used to refill the tanks.

In another embodiment the transportable SOFC electrical power generator carries compressed natural gas as the fuel supply.

In another embodiment the transportable SOFC electrical power generator is supplied a reformate directly from a prereformer.

A transportable generator self contained within an enclosure with its own fuel cell stack, balance of plant, fuel supply, and oxygen supply system is within the enclosure. A system controller and a power conditioning system may also be also provided as part of the enclosure whereby DC and/or AC can be provided for output. In some instances, the transportable SOFC generator may be disassociated from a transport trailer for local use.

In some embodiments a hydrogen refilling system is also provided whereby gaseous hydrogen at a lower pressure can be fed into the transportable generator (through feed lines), and pressurized to a higher psi, and cooled, before storing the gaseous hydrogen in one or more hydrogen storage tanks.

Other features and advantages of the present invention will be set forth, in part, in the descriptions which follow and the accompanying drawings, wherein the preferred embodiments of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations particularly pointed out in the appendent claims.

### BRIEF DESCRIPTION OF THE DRAWINGS

FIG. 1 is an overview of a transportable SOFC electrical generator.

FIG. 2 is an overview of a transportable SOFC electrical generator.

FIG. 3 is a schematic of a SOFC transportable generator.

FIG. 4 is partial cut-away top view of component arrangement inside a transportable SOFC electrical generator.

FIG. 5 is partial cut-away top view of component arrangement inside a transportable SOFC electrical generator.

### DETAILED DESCRIPTION OF THE INVENTION

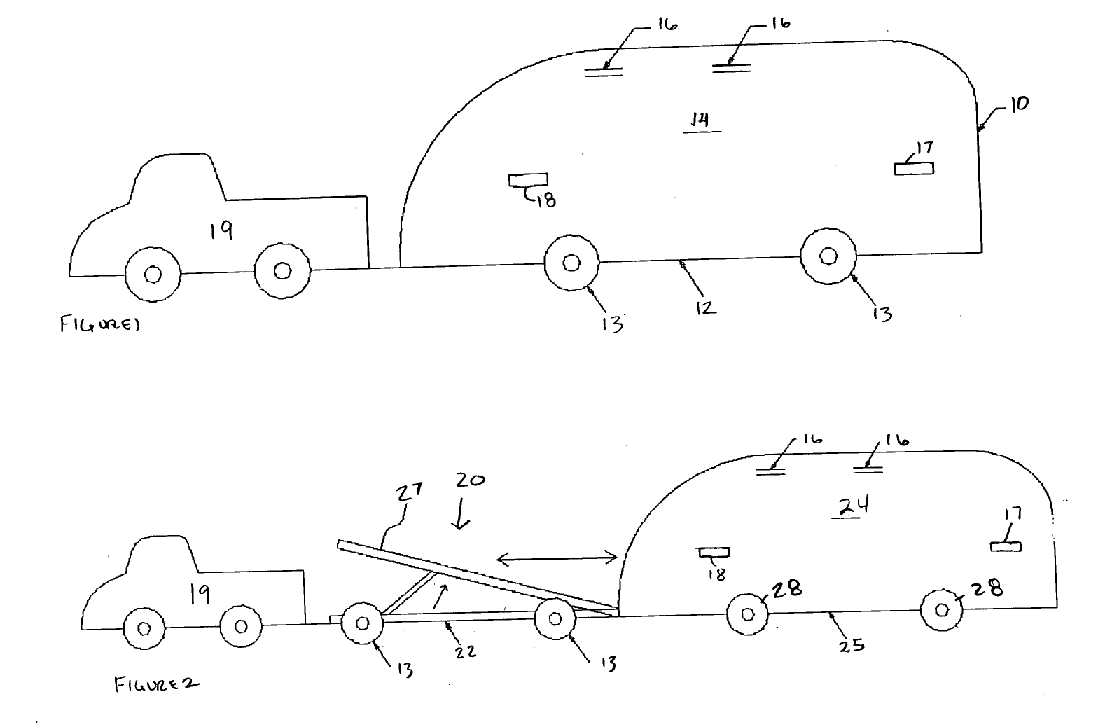

A transportable fuel cell generator within a trailer 10 is shown in FIG. 1. A substantially flat base 12, with wheels 13, which supports a lightweight shell 14 into which the fuel system, distribution system and electrical generation systems are placed. Vents 16 are provided in the lightweight shell 14. An electrical panel 17, accessible from the outside of the lightweight shell 14, at which electricity can be distributed from the transportable fuel cell generator within a trailer 10 is provided. A fueling panel 18 is also provided. The fueling panel 18 provides access to the fuel cell fuel system within the lightweight shell 14. A vehicle 19 can be used to tow the trailer 10.

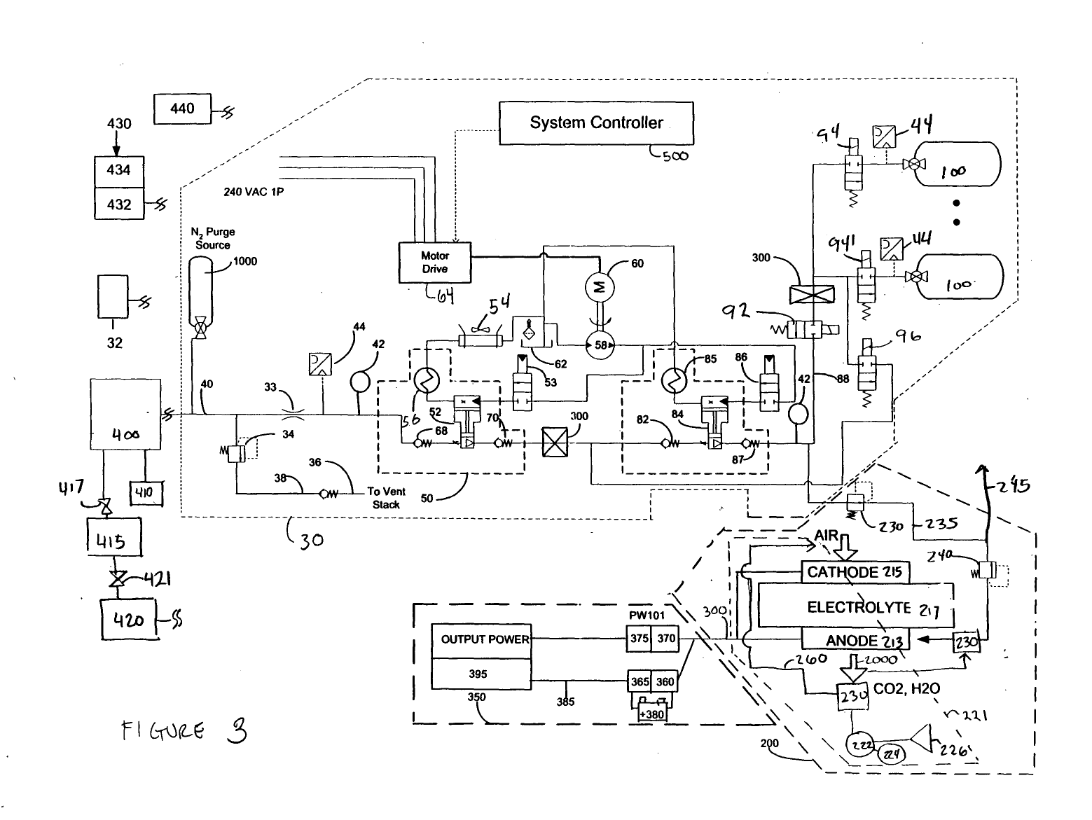

A transportable fuel cell generator on a trailer 20 is shown in FIG. 2. In this embodiment a base 22, with wheels 13, which supports an enclosure module 24. The enclosure module 24 has its own module-base 25. Inside the enclosure module 24 are the fuel system, distribution system and electrical generation systems. The enclosure module 24 has vents 16. The enclosure module 24 can be used while on the base 22, or can be removed from the base 22 and set-up for local usage. An electrical panel 17, accessible from the outside of the enclosure module 24 at which electricity can be distributed is provided. A fueling panel 18 is also provided. The fueling panel 18 provides access to the fuel cell fuel system within enclosure module 24. Removal from the base can be facilitated by lifting the front edge 27 of the base 22 thereby lifting the base 22. Attached to the module-base 25 may be wheels 28 or a sled (extended flat surface) as shown in FIG. 5.

FIG. 3 is a schematic of a transportable SOFC generator. In this embodiment the fuel source is compressed hydrogen gas supplied from one or more internal hydrogen storage tanks 100.

Lightweight internal hydrogen storage tanks 100 should have a pressure rating of up to about 10,000 psi or more and a failure rating, or burst rating, of at least 2.25 times the pressure rating. One such hydrogen storage vessel is the Dynecell™ available from Dynetek Industries, Ltd. in Alberta, Canada. Another lightweight hydrogen storage vessel is the Tri-Shield™ available from Quantum Technologies, Inc. in Irvine, Calif.

Before the fuel cell generator can generate electricity the internal hydrogen storage tanks 100 in the refueling station 10 must be filled. A hydrogen storage subsystem 30 is provided to refill or charge the hydrogen storage tanks 100, a quick connect 32, which can be any standard hydrogen connector, is used to connect an external hydrogen source to hydrogen storage subsystem 30. The external hydrogen source can be a low-pressure source preferably at least about 2400 psi. However, lower pressure sources of at least about 600 psi can be used.

Downstream from the quick connect 32 is a pressure release valve 34. The pressure release valve 34 is a safety element to prevent hydrogen, at a pressure exceeding a pre-determined maximum, from entering the hydrogen storage subsystem 30. If the pressure of hydrogen being introduced through the quick connect 32 exceeds a safe limit a restricted orifice 33 working in combination with a pressure relief valve 34 causes the excess hydrogen to be vented through a vent stack 36. In general, the valves are used to affect the flow of hydrogen within the refueling station. A check valve 38, between the vent stack 36 and pressure relief valve 34, maintains a one-way flow of the flow of pressurized hydrogen being relived from the hydrogen storage subsystem 30. The restrictive orifice 33 also prevents the hydrogen from entering the pressure rated feed line 40 at a rate which causes extreme rapid filling of the lightweight hydrogen storage tanks 100. Prior to connecting the quick connect 32 nitrogen gas, or other inert gas can be introduced into the feed line 40 to purge any air from the feed line. Pressurized nitrogen dispensed from a nitrogen tank 1000 can be introduced through a nitrogen-filling valve 1002.

The feed line 40 should be constructed of stainless steel and typically has a safety margin of 4. Safety margins for a pressurized hydrogen gas line are a measure of burst pressure to operating pressure.

It is important to control the rate of fill of the hydrogen storage tanks 100 and in general the temperature of the gaseous hydrogen. Although a rapid fill is desired, physics dictates that as you increase the fill rate, all things being equal, an elevation in temperature will occur. With an elevation in temperature there is a corresponding decrease in the mass of hydrogen that can be stored at a predetermined input pressure. Accordingly, if the hydrogen entering the hydrogen storage tanks 100 is at an elevated temperature the density of the gaseous hydrogen will also be reduced. Cooling the gaseous hydrogen, by directing it through a cooling unit 300, is used to reduce temperature elevations.

The cooling unit 300 in this embodiment is a finned tube type heat exchanger, however, other heat exchangers, coolers, or radiators which can manage the temperature of the gaseous hydrogen may be used. Temperature is measured at various places on the feed line 40 by temperature sensors 42 which are monitored by a system controller 500 which is typically based on an 8-32 bit microprocessor.

Connections between the feed line 40 sensors, valves, transducers, inlet or outlets, should be constructed to minimize any potential for leakage of hydrogen. Common construction techniques include welds, face seals, metal-to-metal seals and tapered threads. One or more hydrogen leak sensors 43 are also distributed and connected to the system controller 500. The pressure of the gaseous hydrogen is measured by one or more pressure sensors 44 placed in the feed line 40. No specific sensors is called out for but generally the sensor may be a transducer, or MEMS that incorporate polysilicon strain gauge sensing elements bonded to stainless steel diaphragms. The temperature and pressure of the hydrogen, entering the pressure rated feed line 40 can be checked as it passes into the first compressor subsystem 50.

The first compressor subsystem 50 contains an oil cooled first intensifier 52. An intensifier switch 53, connected to the system controller 500, controls the start/stop function of the first intensifier 52. An oil to air heat exchanger 54 for cooling hydraulic oil which is supplied to a first intensifier heat exchanger 56 to cool the first intensifier 52. A hydraulic pump 58, powered by a brushless motor 60, supplies cooling oil from an oil reservoir 62 to the first intensifier heat exchanger 56. A speed control 64 for the brushless motor 60 is provided. A brushless motor 60 is preferred to eliminate the risk of sparks. The system controller 500 receives data from the oil temperature sensor, the gaseous hydrogen temperature sensors 42, the gaseous hydrogen pressure sensors 44, and the hydrogen leak sensors 43. The system controller 500 in turn is used to, among other things, affect the speed control 64.

The intensifier is a device, which unlike a simple compressor, can receive gas at varying pressures and provide an output stream at a near constant pressure. However, it may be suitable in some cases to use a compressor in place of an intensifier. The first intensifier 52 increases the pressure of the incoming gaseous hydrogen about four fold. Within the first compressor subsystem 50, hydrogen gas from the feed line 40 enters the first intensifier 52 through an inlet valve 68. The gaseous hydrogen exits the first intensifier through an outlet check valve 70. At this point, the gaseous hydrogen is directed through a cooling unit 300 to manage any temperature increases in the gaseous hydrogen. The gaseous hydrogen passing through the cooling unit 300 may be directed to enter a second compressor subsystem 80 or into a by-pass feed line 90.

If entering the second compressor subsystem 80 the gaseous hydrogen passes through an inlet check valve 82 which directs it to the second intensifier 84. The oil to air heat exchanger 54 for cooling the hydraulic oil which is supplied to a second intensifier heat exchanger 85 to cool the second intensifier 84. An intensifier switch 86, connects to the system controller 500, and controls the start/stop function of the second intensifier 84. The gaseous hydrogen exits the second intensifier 84 through an outlet check valve 87 and is directed down the inlet/outlet line 88 to a line control valve 92 which directs the gaseous hydrogen through a cooling unit 300 and into the inlet/outlet control valves 94 and 94′ for the lightweight composite hydrogen storage tanks 100 and 100.

The dual compressor sub-systems 50 & 80 are not a limitation. If the storage pressure for the hydrogen gas can be achieved with a single compressor sub-system, the second compressor subsystem can be bypassed or eliminated. By closing the inlet check valve 82 to the second intensifier 84, the gaseous hydrogen exiting the first intensifier 52 is directed through the by-pass feed line 90 and to a by-pass inlevoutlet control valve 96 which directs the flow of gaseous hydrogen to the lightweight composite hydrogen storage tanks 100 and 100. Conversely, in those instances where storage pressure exceeding that which can be efficiently achieved with dual intensifiers is desired, additional intensifiers can be added.

Alternatively, compressed natural gas “CNG” can be stored on the board in tanks and used to supply fuel to the SOFC stack 211. In a compressed natural gas embodiment the high pressure hydrogen storage tanks 100 are replaced with tanks suitable to store compressed natural gas at pressures of up to about 3600 psi. Such tanks may be replaceable or refillable. Once filled such tanks are connected to the SOFC stack 211 when the line control valve 92 is open. The stream of natural gas flows through the inlevoutlet line 88 to a first regulator 240. The first regulator 240 decreases the pressure of the natural gas. The reduced pressure stream of natural gas flows from the first regulator 240 through the fuel cell feed line 245 to a second regulator 250 with vent 255. The second regulator 250 further reduces the pressure of the stream of gas. For the SOFC stack 211 a feed pressure to the anodes 213 of up to about 15 bar is a suitable. As previously described oxygen is supplied to the cathodes 215 by compressing atmospheric air. A device to reform natural gas into a gas stream primarily consisting of hydrogen, methane and carbon monoxide may be placed upstream of the fuel cell feed line.

The heart of the electrical generation system 200 is the SOFC stack 211 and the associated balance of plant. The balance of plant in this embodiment includes an air supply system 221. A heat exchanger 230 uses the waste heat from the exhaust 2000 to preheat the air supply and/or fuel supplies before entry into the anode 213 and/or cathode 215. A stream of gaseous hydrogen is supplied from the storage tanks 100 when the line control valve 92 is open. The stream of hydrogen flows through the inlet/outlet line 88 to a first regulator 240. The first regulator 240 decreases the pressure of the hydrogen gas. In this embodiment the regulators are diaphragm based. There are many types of pressure regulators known in the art and the use of a diaphragm-based regulator is not a limitation. The reduced pressure stream of hydrogen gas flows from the first regulator 240 through the fuel cell feed line 245 to a second regulator 250 with vent 255. The second regulator 250 further reduces the pressure of the stream of hydrogen. For the SOFC a feed pressure to the anode 213 of up to about 15 bar is a suitable.

The SOFC stack 211 operates when fuel, in this embodiment a stream of hydrogen flows into the anodes 213 of the SOFC stack 211. Oxygen is supplied to the cathodes 215 of the SOFC stack 211 via the air supply system 221 which comprises an air compressor 222, a compressor motor 224 an air inlet 226 and a heat exchanger 230. The compressed atmospheric air is directed via the oxygen feed line 260 to the cathodes 215.

The system controller 500 controls the flow of hydrogen via the line control valve 92 and/or the air supply system 221 via the electric motor 224. Varying the hydrogen supply or the oxygen supply is used to control the output of the SOFC stack 211. A SOFC stack's electrical output can be controlled by altering input parameters such as gas pressure, gas flow rate and gas stream temperature. In general, the current density (A/cm2) of the electricity generated will vary with alteration in the input parameters while the voltage remains generally stable. If the voltage output increases past the SOFC stack's nominal rating, the current density will generally decrease.

The electrical current is produced when negatively charged oxygen “0²⁻ migrates through the electrolyte membrane 217. The electrical generation system 200 produces a DC output 300. A SOFC stack between about 20 and about 150 KW is preferred. For this embodiment, a 100 KW SOFC stack 211, which can produce a current between about 100 and 800 volts, is provided. The DC output 300 passes into the power conditioning system 350 both a DC/DC converter 360 with controller 365 and a power inverter 370 with controller 375. The DC/DC converter 360 can be used to step down the SOFC stack 211 voltage and power on board systems such as the air compressor motor 232, other low voltage components, and recharge a back-up battery 380. Although a 100 KW SOFC stack is indicated, the 100 KW size is not a limitation. The size of the stack in KWS and the stack configuration will affect the output in terms of voltage and amperage. The preferred stack for any usage will depend on the voltage and amperage requirements.

The DC output 385 from the DC/DC converter 360 and the AC output 390 from the DC/AC inverter 370 is available for use at an output power panel 395. Referring now to FIGS. 1 and 2, the output power panel 395 in FIG. 3 is located at the electrical panel 17.

Fuel to the SOFC stack 211 may also be provided from a prereformer 400 with controller 410. A hydrocarbon rich fuel is provided from a fuel tank 415. The fuel passes through a valve 417 to the prereformer 400. Reformation of hydrogen rich fuels is well known in the art and therefore a detailed description of the construction of a prereformer is not provided. The prereformer you need not deliver pure hydrogen. Hydrocarbons in the reformate stream can be used directly as fuel for the SOFC 211 stack. One benefit of a SOFC stack 211, as opposed to a PEM stack, is that a pure hydrogen source of fuel is unnecessary and the partial reformation of a fuel stream containing unreformed hydrocarbons (carbon dioxide and/or carbon monoxide) is a sufficient fuel source for the SOFC stack 211.

One alternative hydrogen supply source is a reformer 420. Reformers are well known in the art. Generally a reformer is a combustion device that uses a hydrocarbon fuel 415 to produce hydrogen. The hydrocarbon fuel can be stored on-board in a tank 415. A control valve which can be operated by the system controller 500 feed a hydrocarbon rich fuel into the reformer 420. The reformer 420 strips hydrogen from a hydrocarbon fuel. The hydrogen can then be introduced into the hydrogen storage subsystem 30.

Another alternative hydrogen supply source to feed hydrogen into the hydrogen storage subsystem 30 is an electrolyzer 430 which is comprised of a KOH electrolyzer module 432 and a cooling module 434. One suitable KOH electrolyzer is an IMET electrolyzer manufactured by Vandenborre Hydrogen Systems. The cooling module 434 should be sufficient to reduce the temperature to at or below ambient for maximum volume in the hydrogen storage tanks 100. The cooling module 434 may be a closed loop cooler, receive a water input, or use heat exchangers and or radiators.

A polymer electrolyte membrane (PEM) electrolyzer 440 may be substituted for the IMET electrolyzer. A PEM electrolyzer splits hydrogen from a water source and generates a hydrogen gas stream. Both the electrolyzer and the polymer electrolyte membrane are known in the art and therefore a detailed description of their construction is not necessary.

Both the electrolyzer module 430 and the PEM electrolyzer 440 require electricity to operate. The electricity may be from an electrical grid connection, or other electrical generator. In some instance the electricity to drive the electrolyzer module 430 or the PEM electrolyzer 440 can be obtained from renewable sources such as solar (photovoltaic) or wind-power.

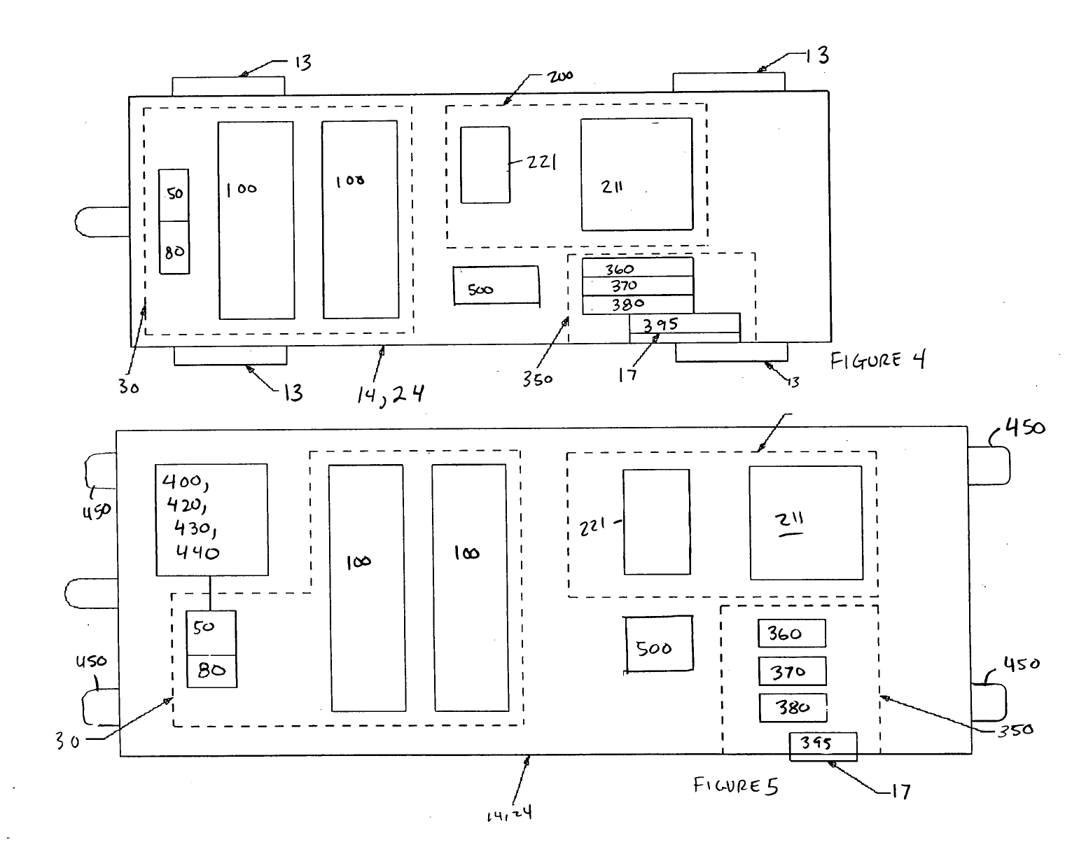

Shown in FIGS. 4 and 5 are alternative component arrangements within a trailer 14 or an enclosure module 24 of the hydrogen storage subsystem 30, electrical generation system 200 and the power conditioning system 350. In FIG. 5 the alternative hydrogen supply sources, reformer 400, electrolyzer 430 and polymer electrolyte membrane (PEM) electrolyzers 440 are also shown.

The transportable fuel cell generator may remain on the trailer as shown in FIG. 4 or be removed (FIG. 2) sleds 450 on the base of an enclosure module 24 are shown in FIG. 5.

Since certain changes may be made in the above apparatus without departing from the scope of the invention herein involved, it is intended that all matter contained in the above description, as shown in the accompanying drawing, shall be interpreted in an illustrative, and not a limiting sense.

1. A solid oxide fuel cell generator comprising: a portable enclosure;
a solid oxide fuel cell stack within the enclosure;
a hydrogen storage means within the enclosure;
a hydrogen supply means at least partially within the enclosure, whereby hydrogen is supplied to the fuel cell stack;
an oxygen supply means at least partially within the enclosure, whereby oxygen is supplied to the fuel cell stack;
a power condition means; and,
at least one system controller.

2. The fuel cell generator of claim 1 wherein the hydrogen storage means comprises:
at least one feed line where into hydrogen can flow;
at least one compressor means connected to the at least one feed line;
one or more hydrogen storage tanks connected to the at least one feed line downstream from the at least one compressor means;
at least one control valve connected to the at least one feed line; and,
the at least one system controller controls at least one of the at least one
control valve and the at least one compressor means, whereby the flow of hydrogen is affected.

3. A solid oxide fuel cell generator comprising:
a portable enclosure;
a solid oxide fuel cell stack within the enclosure;
a hydrogen carbon fuel supply within the enclosure;
a prereformer within the trailer;
an oxygen supply means at least partially within the enclosure, whereby oxygen is supplied to the fuel cell stack;
a power condition means; and
at least one system controller.

4. The fuel cell generator of claim 2 wherein each compressor means comprises an oil-cooled intensifier.

5. The fuel cell generator of claim 2 wherein the oxygen supply means comprises:
at least one air inlet line; and,
at least one air compressor connected at one end to the at least one air inlet line and at the other end to the fuel cell stack.

6. The fuel cell generator of claim 1 wherein the power conditioning means comprises at least one inverter with controller whereby the DC of the fuel cell stack is converted to AC.

7. The fuel cell generator of claim 1 wherein the power conditioning means comprises at least one DC converter with controller whereby the voltage of the DC output of the fuel cell stack is stepped down.

8. The fuel cell generator of claim 1 wherein the power conditioning means comprises:
at least one DC converter with controller whereby the voltage of the DC output of the fuel cell stack can be stepped down; and,
at least one inverter with controller whereby DC output of the fuel cell stack can be converted to AC.

9. The fuel cell generator of claim 8 wherein the system controller also controllers at least one of the inverter controller, the DC converter controller, and the air compressor.

10. The fuel cell generator of claim 1 further comprising a trailer onto which the portable enclosure is mounted.

11. The fuel cell generator of claim 1 further comprising a trailer onto which the portable enclosure is removably mounted.

12. The fuel cell generator of claim 11 wherein the portable enclosure further comprises a moving means.

13. The fuel cell generator of claim 12 wherein the moving means is at least one axle; with at least one wheel at each end; affixed to the enclosure.

14. The fuel cell generator of claim 12 wherein the moving means is a sled.

15. A transportable solid oxide fuel cell generator comprising a trailer;
an enclosure on the trailer;
a solid oxide fuel cell stack within the enclosure;
a hydrogen storage means within the enclosure;
a hydrogen supply means at least partially within the enclosure, whereby hydrogen is supplied to the fuel cell stack;
an oxygen supply means at least partially within the enclosure, whereby oxygen is supplied to the fuel cell stack;
a power conditioning means; and,
at least one system controller.

16. The transportable solid oxide fuel cell generator of claim 15 wherein the hydrogen storage means comprises:
at least one feed line where into hydrogen can flow;
at least one compressor means connected to the at least one feed line;
one or more hydrogen storage tanks connected to the at least one feed line downstream from the at least one compressor means;
at least one control valve connected to the at least one feed line; and
system controller controls at least one of the at least one control valve and the at least one compressor means, whereby the flow of hydrogen is affected.

17. The transportable solid oxide fuel cell generator of claim 16 wherein the oxygen supply means comprises:
at least one air inlet line; and,
at least one air compressor connected at one end to the at least one air inlet line and at the other end to the fuel cell stack.

18. The transportable fuel cell generator of claim 15 wherein the power conditioning means comprises at least one inverter with controller whereby the DC of the fuel cell stack is converted to AC.

19. The transportable solid oxide fuel cell generator of claim 15 wherein the power conditioning means comprises at least one DC converter with controller whereby the voltage of the DC output of the fuel cell stack is stepped down.

20. The transportable solid oxide fuel cell generator of claim 15 wherein the power conditioning means comprises:
at least one DC converter with controller whereby the voltage of the DC output of the fuel cell stack can be stepped down; and,
at least one inverter with controller whereby DC output of the fuel cell stack can be converted to AC.

21. The transportable solid oxide fuel cell generator of claim 20 wherein the system controller also controllers at least one of the inverter controller, the DC converter controller, and the air compressor.

22. A method of providing fuel cell generated electrical power the method comprising:
transporting an enclosure, on a trailer, containing a solid oxide fuel cell stack, balance of plant hydrogen supply means, oxygen supply means, power conditioner and system controller to a location;
generating electricity by providing fuel to the solid oxide fuel cell stack; and
providing a connection to the electricity generated by the solid oxide fuel cell stack.

23. The method of claim 22 further comprising disassociating the enclosure from the trailer before generating the electricity.

24. The method of claim 22 the method further comprising conditioning the electricity generated from the fuel cell stack before providing a connection to the electricity.

25. The method of claim 22 when the fuel supplied is hydrocarbon reformate and oxygen from compressed atmospheric air.
